(19) United States
(12) Patent Application Publication
(10) Pub. No.: US 2020/0143430 A1
(43) Pub. Date: May 7, 2020

(54) TAPPING MEDIA CONNECTIONS FOR MONITORING MEDIA DEVICES

(71) Applicant: The Nielsen Company (US), LLC, New York, NY (US)

(72) Inventor: Sandeep Tapse, Tampa, FL (US)

(21) Appl. No.: 16/593,711

(22) Filed: Oct. 4, 2019

Related U.S. Application Data
(63) Continuation of application No. 15/668,538, filed on Aug. 3, 2017, now abandoned.

(51) Int. Cl. G06Q 30/02; G06Q 50/00; G06F 16/435

(52) U.S. Cl. CPC G06Q 30/0271; G06F 16/437; G06Q 50/01; G06Q 30/0201

(57) ABSTRACT

Example methods, apparatus, systems and articles of manufacture (e.g., physical storage media) for tapping media connections to monitor media devices are disclosed. Example media monitoring methods disclosed herein include capturing and storing image data corresponding to image frames of media data transmitted in a media signal from a media source device to a media display device. Disclosed example methods also include detecting audio transitions in audio data of the media data transmitted in the media signal. Disclosed example methods further include determining, in response to detection of a first audio transition in the audio data, application identification information in an image frame captured prior to the detection of the first audio transition. In some disclosed examples, the application identification information is to identify a media application executed by the media source device to provide the media data transmitted in the media signal.

### RELATED APPLICATION(S)

This patent arises from a continuation of U.S. patent application Ser. No. 15/668,538 (now U.S. Pat. No. ______), which is entitled “TAPPING MEDIA CONNECTIONS FOR MONITORING MEDIA DEVICES,” and which was filed on Aug. 3, 2017. Priority to U.S. patent application Ser. No. 15/668,538 is claimed. U.S. patent application Ser. No. 15/668,538 is hereby incorporated herein by reference in its entirety.

### FIELD OF THE DISCLOSURE

This disclosure relates generally to media monitoring and, more particularly, to tapping media connections for monitoring media devices.

### BACKGROUND

Audience measurement systems typically include one or more site meters to monitor media presented by one or more media display devices located at a monitored site. In some arrangements, the monitored media display device may receive media from one or more media source devices, such as, but not limited to, a set-top box (STB), a digital versatile disk (DVD) player, a Blu-ray disk™ player, a gaming console, a computer, etc. In recent years, many such media source devices have been enhanced with Internet connectivity and media applications to enable the media source devices to access and stream media from sources on the Internet, in addition to implementing their primary media source functionality. Furthermore, other media source devices capable of providing media to a monitored media device include dedicated over-the-top devices that receive and process streaming media from Internet sources via Internet protocol (IP) communications.

### BRIEF DESCRIPTION OF THE DRAWINGS

FIG. 1 is a block diagram of an example system including example media connection tappers to tap media connections for monitoring media devices in accordance with the teachings of this disclosure.

FIG. 2 is a block diagram of an extended media connection tapper arrangement for use in the example system of FIG. 1.

FIG. 3 is a block diagram of an example media connection tapper that may be used in the example of FIG. 1.

FIG. 4 is a block diagram of an example central facility that may be used in the example of FIG. 1.

FIGS. 5-7 are flowcharts representative of example computer readable instructions that may be executed to implement the example connection tapper of FIG. 3.

FIG. 8 is a flowchart representative of example computer readable instructions that may be executed to implement the example central facility of FIG. 4.

FIG. 9 is a block diagram of an example processor platform structured to execute the example computer readable instructions of FIGS. 5, 6 and/or 7 to implement the example media connection tapper of FIG. 3.

FIG. 10 is a block diagram of an example processor platform structured to execute the example computer readable instructions of FIG. 8 to implement the example central facility of FIG. 4.

Wherever possible, the same reference numbers will be used throughout the drawing(s) and accompanying written description to refer to the same or like parts, elements, etc.

### DETAILED DESCRIPTION

Example methods, apparatus, systems and articles of manufacture (e.g., physical storage media) for tapping media connections to monitor media devices are disclosed herein. Example media connection tappers disclosed herein for tapping media connections to monitor media devices include an image grabber to capture and store image data corresponding to image frames of media data transmitted in a media signal from a media source device (e.g., such as a set-top-box, and over-the-top Internet appliance, digital versatile disk (DVD) player, etc.) to a media display device (e.g., a television, a monitor, a computer, etc.). The example media connection tappers also include an audio detector to detect audio transitions in audio data of the media data transmitted in the media signa. The example media connection tappers further include an application identifier to determine, in response to detection of a first audio transition by the audio detector, application identification information in an image frame captured prior to the detection of the first audio transition. In some examples, the application identification information is to identify a media application (e.g., an app, media player, a web browser to access a media service provider, etc.) executed by the media source device to provide the media data transmitted in the media signal.

Some disclosed example media connection tappers include a first connector to communicatively couple to the media source device, and a second connector to communicatively couple to the media display device. Some such disclosed example methods also include a signal tapper to pass the media signal from the first connector to the second connector, and also provide access to the media data of the media signal for the image grabber and the audio detector.

Additionally or alternatively, in some disclosed examples, the first audio transition corresponds to detection of a first audio watermark in the audio data after no audio watermarks have been detected in the audio data for a time period. In some such examples, the audio detector of the media connection tapper includes a watermark detector to detect audio watermarks, including the first audio watermark, in the audio data. In some such examples, the audio detector of the media connection tapper also includes a transition detector to detect the first audio transition when the watermark detector detects the first watermark in the audio data after no audio watermarks have been detected in the audio data for the time period.

Additionally or alternatively, in some disclosed examples, the first audio transition corresponds the audio data satisfying at least a first audio level threshold after not having satisfied the first audio level threshold for a time period. In some such examples, the audio detector of the media connection tapper includes a level detector to detect an audio level of the audio data. In some such examples, the level detector also is to compare the audio level of the audio data to the first audio level threshold to detect the first audio transition.

Additionally or alternatively, in some disclosed examples, to determine the application identification information, the application identifier of the media connection tapper is further to access the image frame in memory based on the image frame having a capture time prior to a time of the first audio transition. In some such examples, the application identifier of the media connection tapper is also to perform image processing on the image frame to identify first graphical data of the image frame matching reference graphical data corresponding to at least one of a set of one or more reference media applications. In some such examples, the application identifier of the media connection tapper is further to determine the application identification information based on the first graphical data identified in the image frame. For example, the reference graphical data may include logos associated with the one or more reference media applications. In some such examples, the application identifier of the media connection tapper is to access a reference application identifier stored in association with a first one of the logos matching the first graphical data of the image frame, and include the reference application identifier in the application identification information.

Additionally or alternatively, some disclosed example media connection tappers further include a communication interface to transmit the application identification information via a network to a remote processing device (e.g., such as a remote data processing facility, another meter monitoring the media display device and/or media source device, etc.).

These and other example methods, apparatus, systems and articles of manufacture (e.g., physical storage media) to implement tapping of media connections for monitoring media devices are disclosed in further detail below.

As mentioned above, audience measurement systems typically include one or more site meters to monitor the media presented by one or more media display devices located at a monitored site. In some arrangements, the monitored media display device may receive media from one or more media source devices, such as, but not limited to, an STB, a DVD player, a Blu-ray disk™ player, a gaming console, a computer, etc. Many such media source devices have Internet connectivity and include media applications capable of accessing and stream media from sources on the Internet, in addition to implementing their primary media source functionality. Furthermore, other media source devices capable of providing media to a monitored media device include dedicated over-the-top devices that receive and process streaming media from Internet sources via Internet protocol (IP) communications.

To properly credit a source of media presented by a monitored media display device, audience measurement entities (AMEs) implementing the audience measurement systems may desire to identify a particular media application executed by a media source device to provide the media data to the media display device. For example, a DVD player that is in communication with and configured to provide media data to a monitored media device may include one or more media applications (e.g., secondary media application(s)) capable of accessing and streaming media via the Internet, in addition to performing the DVD player's primary functionality of playing DVDs (e.g., the media source device's primary media application). In such an example, knowing that the DVD player is providing media data to the monitored media display device is not sufficient to accurately credit the source of the media, as the media could be coming from a DVD being played by the DVD player or a media application accessing and streaming media via the Internet.

To enable an AME to identify a media application being executed by media source devices to provide media data to a monitored media display device, some prior audience measurement systems employ software meters to be executed on the media source devices. A software meter is typically downloaded or otherwise installed on a media source device and executed to monitor the operation of the device, such as the application(s) executing on the device, data being received and transmitted by the device, etc. The monitoring performed by such a software meter may be considered invasive because the meter is installed on and modifies operation of the media source device. Furthermore, use of such software meters may require permission from, and cooperation with, manufacturers of the media source devices, or may be limited to media source devices having open computing platforms.

In contrast with such prior systems, audience measurement systems that implement tapping of media connections for monitoring media devices, as disclosed herein, are able to ascertain and properly credit which media application of a media source device is providing media data to a monitored media device in a manner that is non-invasive and does not involve use of a software meter. In fact, example techniques disclosed herein to tap media connections for monitoring media devices involve no modifications to the media sources devices or the media display device being monitored. As described in further detail below, disclosed examples for tapping media connections achieve such operation by inserting media connection tappers (also referred to herein as media taps, taps, etc.) between a monitored media display device (e.g., a television) and the media source(s) (e.g., STB, DVD player, game console, OTT device, or other peripheral device, etc.) in communication with (e.g., communicatively coupled/connected to) the media display device. Example media connection tappers disclosed herein process audio data and image data obtained by tapping media signals transmitted from the media source device(s) to the monitored media display device to enable identification of the media source device providing media to the display device. Disclosed example media connection tappers further enable identification, in a non-invasive manner, of a particular media application executed (e.g., launched) by the media source device to provide the media data to the monitored media device.

For example, to identify the particular media application executed by the media source device to provide the media data, a disclosed example media connection tapper captures image frames (e.g., video frames) and monitors audio data transmitted by the media source device to detect an audio transition to a valid audio condition (e.g., corresponding to audio data that satisfies an audio level threshold, includes valid audio watermarks, etc.) after a period of time in which no valid audio conditions have been detected (e.g., corresponding to silence, or audio data that does not satisfy an audio level threshold, or is otherwise unknown). In response to detecting such an audio transition, the disclosed example media connection tapper processes images frames captured before the detected audio transition to identify, in the prior captured image frames, reference graphical data (e.g., a logo and/or other indicator(s), such as menus, etc.) associated with a possible media application (e.g., Netflix®) capable of being executed by the media source device to provide media data to the monitored media display device. The disclosed example media connection tapper then uses reference media application identification information (e.g., such as an application identifier) stored in association with the reference graphical data found in the captured image to identify the particular media application executed by the media source device to provide the media data to the monitored media display device.

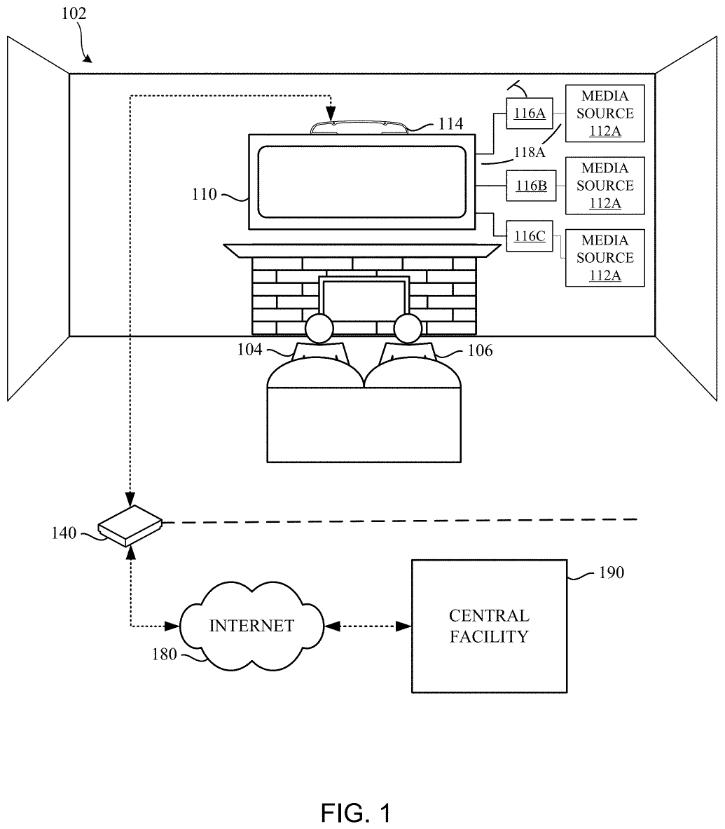

Turning to the figures, FIG. 1 is an illustration of an example audience measurement system constructed to implement tapping of media connections for monitoring media devices in accordance with the teachings of this disclosure. In the illustrated example of FIG. 1, an example media presentation environment 102 includes example panelists 104, 106, an example media display device 110 (also referred to as a media presentation device) that receives media from example media source devices 112A-C, and an example meter 114. The example meter 114 identifies the media presented by the example media display device 110 and reports media monitoring information to an example central facility 190 of an example audience measurement entity via an example gateway 140 and an example network 180. In some examples, the meter 114 is referred to as a site meter, a device meter, an audience measurement device, etc. As disclosed in further detail below, the media presentation environment 102 of the illustrated example further includes example media connection tappers 116A-C to tap media connections for monitoring media devices, such as the media display device 110 and one or more of the media source devices 112A-C, in accordance with the teachings of this disclosure

In the illustrated example of FIG. 1, the example media presentation environment 102 is a room of a household (e.g., a room in a home of a panelist, such as the home of a “Nielsen family”). In the illustrated example of FIG. 1, the example panelists 104, 106 of the household have been statistically selected to develop media ratings data (e.g., television ratings data) for a population/demographic of interest. People become panelists via, for example, a user interface presented on a media device (e.g., via the media display device 110, via a website, etc.). People become panelists in additional or alternative manners such as, for example, via a telephone interview, by completing an online survey, etc. Additionally or alternatively, people may be contacted and/or enlisted using any desired methodology (e.g., random selection, statistical selection, phone solicitations, Internet advertisements, surveys, advertisements in shopping malls, product packaging, etc.). In some examples, an entire family may be enrolled as a household of panelists. That is, while a mother, a father, a son, and a daughter may each be identified as individual panelists, their viewing activities typically occur within the family's household.

In the illustrated example of FIG. 1, one or more panelists 104, 106 of the household have registered with an audience measurement entity (e.g., by agreeing to be a panelist) and have provided their demographic information to the audience measurement entity as part of a registration process to enable associating demographics with media exposure activities (e.g., television exposure, radio exposure, Internet exposure, etc.). The demographic data includes, for example, age, gender, income level, educational level, marital status, geographic location, race, etc., of a panelist. While the example media presentation environment 102 is a household in the illustrated example of FIG. 1, the example media presentation environment 102 can additionally or alternatively be any other type(s) of environments such as, for example, a theater, a restaurant, a tavern, a retail location, an arena, etc.

In the illustrated example of FIG. 1, the example media display device 110 is a television. However, the example media display device 110 can correspond to any type of audio, video and/or multimedia device capable of presenting media audibly and/or visually. In some examples, the media display device 110 (e.g., a television) may communicate audio to another media device (e.g., an audio/video receiver) for output by one or more speakers (e.g., surround sound speakers, a sound bar, etc.). For example, the media display device 110 can correspond to a television and/or display device that supports the National Television Standards Committee (NTSC) standard, the Phase Alternating Line (PAL) standard, the Système Électronique pour Couleur avec Mémoire (SECAM) standard, a standard developed by the Advanced Television Systems Committee (ATSC), such as high definition television (HDTV), a standard developed by the Digital Video Broadcasting (DVB) Project, etc. As another example, the media display device 110 can correspond to a multimedia computer system, a personal digital assistant, a cellular/mobile smartphone, a radio, a home theater system, stored audio and/or video played back from a memory, such as a digital video recorder or a digital versatile disc, a webpage, and/or any other communication device capable of presenting media to an audience (e.g., the panelists 104, 106).

The media display device 110 receives media from the media source devices 112A-C. The media source devices 112A-C may be devices capable of providing media from any type of media provider(s), such as, but not limited to, a cable media service provider, a radio frequency (RF) media provider, an Internet based provider (e.g., IPTV), a satellite media service provider, etc., and/or any combination thereof. The media may be radio media, television media, pay per view media, movies, Internet Protocol Television (IPTV), satellite television (TV), Internet radio, satellite radio, digital television, digital radio, stored media (e.g., a compact disk (CD), a Digital Versatile Disk (DVD), a Blu-ray disk, etc.), any other type(s) of broadcast, multicast and/or unicast medium, audio and/or video media presented (e.g., streamed) via the Internet, a video game, targeted broadcast, satellite broadcast, video on demand, etc. Advertising, such as an advertisement and/or a preview of other programming, etc., is also typically included in the media. For example, the media source devices 112A-C can include, but are not limited to, one or more STB(s) (e.g., cable STBs, satellite STBs, etc.), DVD player(s), Blu-ray disk™ player(s), a gaming console(s), OTT internet appliance(s), computer(s), etc.

In examples disclosed herein, an audience measurement entity provides the meter 114 to the panelist 104, 106 (or household of panelists) such that the meter 114 may be installed by the panelist 104, 106 by simply powering the meter 114 and placing the meter 114 in the media presentation environment 102 and/or near the media display device 110 (e.g., near a television set). In some examples, more complex installation activities may be performed such as, for example, affixing the meter 114 to the media display device 110, electronically connecting the meter 114 to the media display device 110, etc. The example meter 114 detects exposure to media and electronically stores monitoring information (e.g., a code detected with the presented media, a signature of the presented media, an identifier of a panelist present at the time of the presentation, a timestamp of the time of the presentation) of the presented media. The stored monitoring information is then transmitted back to the central facility 190 via the gateway 140 and the network 180. While the media monitoring information is transmitted by electronic transmission in the illustrated example of FIG. 1, the media monitoring information may additionally or alternatively be transferred in any other manner, such as, for example, by physically mailing the meter 114, by physically mailing a memory of the meter 114, etc.

The meter 114 of the illustrated example combines audience measurement data and people metering data. For example, audience measurement data is determined by monitoring media output by the media display device 110 and/or other media device(s), and audience identification data (also referred to as demographic data, people monitoring data, etc.) is determined from people monitoring data provided to the meter 114. Thus, the example meter 114 provides dual functionality of an audience measurement meter that is to collect audience measurement data, and a people meter that is to collect and/or associate demographic information corresponding to the collected audience measurement data.

For example, the meter 114 of the illustrated example collects media identifying information and/or data (e.g., signature(s), fingerprint(s), code(s), tuned channel identification information, time of exposure information, etc.) and people data (e.g., user identifiers, demographic data associated with audience members, etc.). The media identifying information and the people data can be combined to generate, for example, media exposure data (e.g., ratings data) indicative of amount(s) and/or type(s) of people that were exposed to specific piece(s) of media distributed via the media display device 110. To extract media identification data, the meter 114 of the illustrated example of FIG. 1 monitors for watermarks (sometimes referred to as codes) included in the presented media and/or generates signatures (sometimes referred to as fingerprints) representative of the presented media

Audio watermarking is a technique used to identify media such as television broadcasts, radio broadcasts, advertisements (television and/or radio), downloaded media, streaming media, prepackaged media, etc. Existing audio watermarking techniques identify media by embedding one or more audio codes (e.g., one or more watermarks), such as media identifying information and/or an identifier that may be mapped to media identifying information, into an audio and/or video component. In some examples, the audio or video component is selected to have a signal characteristic sufficient to hide the watermark. As used herein, the terms “code” or “watermark” are used interchangeably and are defined to mean any identification information (e.g., an identifier) that may be inserted or embedded in the audio or video of media (e.g., a program or advertisement) for the purpose of identifying the media or for another purpose such as tuning (e.g., a packet identifying header). As used herein “media” refers to audio and/or visual (still or moving) content and/or advertisements. To identify watermarked media, the watermark(s) are extracted and used to access a table of reference watermarks that are mapped to media identifying information.

Unlike media monitoring techniques based on codes and/or watermarks included with and/or embedded in the monitored media, fingerprint or signature-based media monitoring techniques generally use one or more inherent characteristics of the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s)(e.g., the audio and/or video signals forming the media presentation being monitored). A signature may be a series of signatures collected in series over a timer interval. A good signature is repeatable when processing the same media presentation, but is unique relative to other (e.g., different) presentations of other (e.g., different) media. Accordingly, the term “fingerprint” and “signature” are used interchangeably herein and are defined herein to mean a proxy for identifying media that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media sources. Various comparison criteria, such as a cross-correlation value, a Hamming distance, etc., can be evaluated to determine whether a monitored signature matches a particular reference signature. When a match between the monitored signature and one of the reference signatures is found, the monitored media can be identified as corresponding to the particular reference media represented by the reference signature that with matched the monitored signature. Because attributes, such as an identifier of the media, a presentation time, a broadcast channel, etc., are collected for the reference signature, these attributes may then be associated with the monitored media whose monitored signature matched the reference signature. Example systems for identifying media based on codes and/or signatures are long known and were first disclosed in Thomas, U.S. Pat. No. 5,481,294, which is hereby incorporated by reference in its entirety.

Depending on the type(s) of metering the meter 114 is to perform, the meter 114 can be physically coupled to the media display device 110 or may be configured to capture audio emitted externally by the media display device 110 (e.g., free field audio) such that direct physical coupling to the media display device 110 is not required. For example, the meter 114 of the illustrated example may employ non-invasive monitoring not involving any physical connection to the media display device 110 (e.g., via Bluetooth® connection, WIFI® connection, acoustic sensing via one or more microphone(s) and/or other acoustic sensor(s), etc.) and/or invasive monitoring involving one or more physical connections to the media display device 110 (e.g., via USB connection, a High Definition Media Interface (HDMI) connection, an Ethernet cable connection, etc.).

In examples disclosed herein, to monitor media presented by the media display device 110, the meter 114 of the illustrated example senses audio (e.g., acoustic signals or ambient audio) output (e.g., emitted) by the media display device 110. For example, the meter 114 processes the signals obtained from the media display device 110 to detect media and/or source identifying signals (e.g., audio watermarks, audio signatures) embedded in and/or generated from portion(s) (e.g., audio portions) of the media presented by the media display device 110. To, for example, sense ambient audio output by the media display device 110, the meter 114 of the illustrated example includes an example acoustic sensor (e.g., a microphone). In some examples, the meter 114 may process audio signals obtained from the media display device 110 via a direct cable connection to detect media and/or source identifying audio watermarks embedded in such audio signals.

To generate exposure data for the media, identification(s) of media to which the audience is exposed are correlated with people data (e.g., presence information) collected by the meter 114. The meter 114 of the illustrated example collects inputs (e.g., audience identification data) representative of the identities of the audience member(s) (e.g., the panelists 104, 106). In some examples, the meter 114 collects audience identification data by periodically and/or a-periodically prompting audience members in the media presentation environment 102 to identify themselves as present in the audience. In some examples, the meter 114 responds to predetermined events (e.g., when the media display device 110 is turned on, a channel is changed, an infrared control signal is detected, etc.) by prompting the audience member(s) to self-identify. The audience identification data and the exposure data can then be complied with the demographic data collected from audience members such as, for example, the panelists 104, 106 during registration to develop metrics reflecting, for example, the demographic composition of the audience. The demographic data includes, for example, age, gender, income level, educational level, marital status, geographic location, race, etc., of the panelist.

In some examples, the meter 114 may be configured to receive panelist information via an input device such as, for example, a remote control, an Apple® iPad®, a cell phone, etc. In such examples, the meter 114 prompts the audience members to indicate their presence by pressing an appropriate input key on the input device. The meter 114 of the illustrated example may also determine times at which to prompt the audience members to enter information to the meter 114. In some examples, the meter 114 of FIG. 1 supports audio watermarking for people monitoring, which enables the meter 114 to detect the presence of a panelist-identifying metering device in the vicinity (e.g., in the media presentation environment 102) of the media display device 110. For example, the acoustic sensor of the meter 114 is able to sense example audio output (e.g., emitted) by an example panelist-identifying metering device, such as, for example, a wristband, a cell phone, etc., that is uniquely associated with a particular panelist. The audio output by the example panelist-identifying metering device may include, for example, one or more audio watermarks to facilitate identification of the panelist-identifying metering device and/or the panelist 104 associated with the panelist-identifying metering device.

The meter 114 of the illustrated example communicates with a remotely located central facility 190 of the audience measurement entity. In the illustrated example of FIG. 1, the example meter 114 communicates with the central facility 190 via a gateway 140 and a network 180. The example meter 114 of FIG. 1 sends media identification data and/or audience identification data to the central facility 190 periodically, a-periodically and/or upon request by the central facility 190.

The example gateway 140 of the illustrated example of FIG. 1 can be implemented by a router that enables the meter 114 and/or other devices in the media presentation environment (e.g., the media display device 110) to communicate with the network 180 (e.g., the Internet.)

In some examples, the example gateway 140 facilitates delivery of media from the media source(s) 112 to the media display device 110 via the Internet. In some examples, the example gateway 140 includes gateway functionality such as modem capabilities. In some other examples, the example gateway 140 is implemented in two or more devices (e.g., a router, a modem, a switch, a firewall, etc.). The gateway 140 of the illustrated example may communicate with the network 126 via Ethernet, a digital subscriber line (DSL), a telephone line, a coaxial cable, a USB connection, a Bluetooth connection, any wireless connection, etc.

In some examples, the example gateway 140 hosts a Local Area Network (LAN) for the media presentation environment 102. In the illustrated example, the LAN is a wireless local area network (WLAN), and allows the meter 114, the media display device 110, etc., to transmit and/or receive data via the Internet. Alternatively, the gateway 140 may be coupled to such a LAN.

The network 180 of the illustrated example can be implemented by a wide area network (WAN) such as the Internet. However, in some examples, local networks may additionally or alternatively be used. Moreover, the example network 180 may be implemented using any type of public or private network such as, but not limited to, the Internet, a telephone network, a local area network (LAN), a cable network, and/or a wireless network, or any combination thereof

The central facility 190 of the illustrated example is implemented by one or more servers. The central facility 190 processes and stores data received from the meter(s) 114. For example, the example central facility 190 of FIG. 1 combines audience identification data and program identification data from multiple households to generate aggregated media monitoring information. The central facility 190 generates reports for advertisers, program producers and/or other interested parties based on the compiled statistical data. Such reports include extrapolations about the size and demographic composition of audiences of content, channels and/or advertisements based on the demographics and behavior of the monitored panelists.

As noted above, the meter 114 of the illustrated example provides a combination of media metering and people metering. The meter 114 of FIG. 1 includes its own housing, processor, memory and/or software to perform the desired media monitoring and/or people monitoring functions. The example meter 114 of FIG. 1 is a stationary device disposed on or near the media display device 110. To identify and/or confirm the presence of a panelist present in the media presentation environment 102, the example meter 114 of the illustrated example includes a display. For example, the display provides identification of the panelists 104, 106 present in the media presentation environment 102. For example, in the illustrated example, the meter 114 displays indicia (e.g., illuminated numerical numerals 1, 2, 3, etc.) identifying and/or confirming the presence of the first panelist 104, the second panelist 106, etc. In the illustrated example, the meter 114 is affixed to a top of the media display device 110. However, the meter 114 may be affixed to the media device in any other orientation, such as, for example, on a side of the media display device 110, on the bottom of the media display device 110, and/or may not be affixed to the media display device 110. For example, the meter 114 may be placed in a location near the media display device 110.

As noted above, the example media connection tappers 116A-C (also referred to herein as taps 116A-C) are included in the illustrated example of FIG. 1 to tap media connections for monitoring media devices, such as the example media display device 110 and the example media source devices 112A-C, in accordance with the teachings of this disclosure. Examples of media connections that can be tapped by one or more of the example media connection tappers 116A-C include wired (or cabled) and/or wireless media connections. For example, a given media connection tapper 116A-C can be implemented to tap one or more wired connections, such as, but not limited to, a high-definition multimedia interface (HDMI) connection, a universal serial bus (USB) connection, an Ethernet connection, an analog coaxial cable connection, etc. Additionally or alternatively, a given example media connection tapper 116A-C can be implemented to tap one or more wireless connections, such as, but not limited to, a Wi-Fi® connection, a Bluetooth® connection, an infrared (IR) connection, a radio frequency (RF) connections, etc.

In the illustrated example, the media connection tapper 116A is in communication with (e.g., communicatively coupled/connected to) the media display device 110 and the media source device 112A to permit the media connection tapper 116A to tap the media connection between the media display device 110 and the media source device 112A. Similarly, in the illustrated example, the media connection tapper 116B is in communication with (e.g., communicatively coupled/connected to) the media display device 110 and the media source device 112B to permit the media connection tapper 116B to tap the media connection between the media display device 110 and the media source device 112B. Similarly, in the illustrated example, the media connection tapper 116C is in communication with (e.g., communicatively coupled/connected to) the media display device 110 and the media source device 112C to permit the media connection tapper 116C to tap the media connection between the media display device 110 and the media source device 112C. As used herein, the phrases “in communication,” “communicatively coupled,” and “communicatively connected,” including variances thereof, encompass direct communication and/or indirect communication through one or more intermediary components and do not require direct physical (e.g., wired) communication and/or constant communication, but rather additionally includes selective communication at periodic or aperiodic intervals, as well as one-time events. Furthermore, as used herein, the terms “connected” and “interconnected” are synonymous with the phrases “in communication with” and “coupled to,” unless specified otherwise.

For convenience and without loss of generality, implementation and operation of the example media connection tappers 116A-C in the illustrated example of FIG. 1 is described from the perspective of the media connection tapper 116A. In the illustrated example, the media connection tapper 116A is connected to each of the media display device 110 and the media source device 112A, as well as being in an example media communication path 118A between the media display device 110 and the media source device 112A. As such, the media connection tapper 116A bridges the media communication path 118A between the media display device 110 and the media source device 112A, thereby allowing media signals to be transmitted from the media source device 112A to the media display device 110 via the media communication path 118A between the two devices. For example, the media connection tapper 116A can be connected to the media display device 110 via a first HDMI connection (e.g., a first HDMI cable) and to the media source device 112A via a second HDMI connection (e.g., a second HDMI cable). In such an example, the media connection tapper 116A implements an HDMI bridge between the first HDMI connection and the second HDMI connection to implement the media connection path 118A between the media display device 110 and the media source device 112A, thereby allowing media signals to be transmitted from the media source device 112A to the media display device 110.

In addition to bridging the media communication path 118A between the media display device 110 and the media source device 112A, the example media connection tapper 116A also provides access to the data included in the signals transmitted via the media communication path 118A between the media source device 112A and the media display device 110. For example, the media connection tapper 116A may copy or otherwise provide access to identification data included in a control signal transmitted via the media communication path 118A from the media source device 112A to the media display device 110. The identification data may include, for example, a device name, a device serial number, a device address (e.g., such as a medium control address or MAC address), etc., of the media source device 112A. Such information may be used by the media connection tapper 116A to identify which source (e.g., the media source device 112A or another source) is providing media data to the media display device 110.

In the illustrated example, the media connection tapper 116A further provides access to image data and audio data of media data included in media signals transmitted via the media communication path 118A from the media source device 112A to the media display device 110. For example, the media connection tapper 116A may copy or otherwise provide access to such image data and audio data for one or more processing elements implemented in the media connection tapper 116A. The media connection tapper 116A uses the image data and audio data accessed on the media connection path 118A between the media source device 112A to the media display device 110 to, among other things, enable identification, in a non-invasive manner, of a particular media application executed (e.g., launched) by the media source device 112A to provide the media data to the monitored media device 110. Examples of possible media applications that can be executed by the media source device 112A and identified by the media connection tapper 116A include, but are not limited to, media applications associated with online media providers (e.g., such as Netflix®, Hulu®, Amazon®, etc.), media applications providing digital video recorder (DVR) features, media applications implemented by a computer (e.g., such as Windows Media Player), Internet browser applications, applications implementing menus providing access to different features of the media source device 112A, etc.

For example, to identify the particular media application executed by the media source device 112A to provide the media data to the media display device 110, the example media connection tapper 116A captures image data corresponding to image frames (e.g., video frames) of the media data, as well as monitors audio data, transmitted via the media connection path 118A by the media source device 112A. The media connection tapper 116A monitors the audio data to detect an audio transition to a valid audio condition (e.g., corresponding to audio data that satisfies an audio level threshold, includes valid audio watermarks, etc.) after a time period (e.g., tens of second, a minute, several minutes, etc.) in which no valid audio conditions have been detected (e.g., corresponding to silence or audio data that does not satisfy an audio level threshold or is otherwise unknown). The time period may be user configurable, initialized in advance, hard-coded, etc. In response to detecting such an audio transition, the media connection tapper 116A processes images frames captured before the detected audio transition to identify, in the prior captured image frame, reference graphical data (e.g., a logo and/or other indicator(s), such as menus, etc.) associated with a possible media application (e.g., a Netflix® application, a Hulu® application, an Amazon® application, a DVR application, a media player, an Internet browser, a menu application, etc.) capable of being executed by the media source device 112A to provide the media data to the monitored media display device 110. The media connection tapper 116A of the illustrated example then uses reference media application identification information (e.g., such as an application identifier) stored in associated with the reference graphical data found in the captured image to determine application identification information identifying the particular media application executed by the media source device 112a to provide the media data to the monitored media display device 110. In some examples, the media connection tapper 116A reports this application identification information via the network 180 to the central facility 190 to permit the central facility 190 to credit the identified media application executed by the media source device 112a as providing the media data to the media display device 110. In some examples, the media connection tapper 116A reports this application identification information to the meter 114 for inclusion on the media monitoring information reported via the network 180 to the central facility 190.

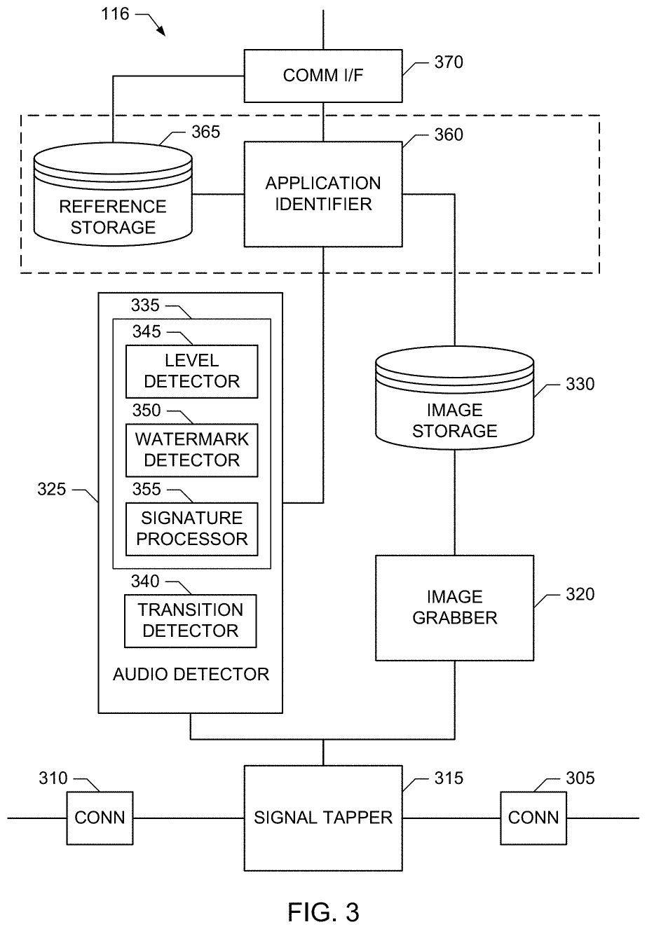

A block diagram of an example implementation of the media connection tapper 116A is illustrated in FIG. 3, which is described in further detail below. In the illustrated example of FIG. 1, the media connection tappers 116B-C operate relative to the media source devices 112B-C in a manner similar to the manner in which the media connection tapper 116A operates relative to the media source device 112A. Also, although the illustrated example of FIG. 1 depicts three media source devices 112A-C connected to the monitored media display device 110 via three media connection tappers 116A-C, any number of media source devices 112A-C may be tapped by any number of media connection tappers 116A-C in accordance with the teachings of this disclosure. Furthermore, in some examples, a subset of the media source devices 112A-C connected to the monitored media display device 110 are tapped via associated media connection tappers 116A-C in accordance with the teachings of this disclosure, whereas the remaining media source devices 112A-C are not tapped.

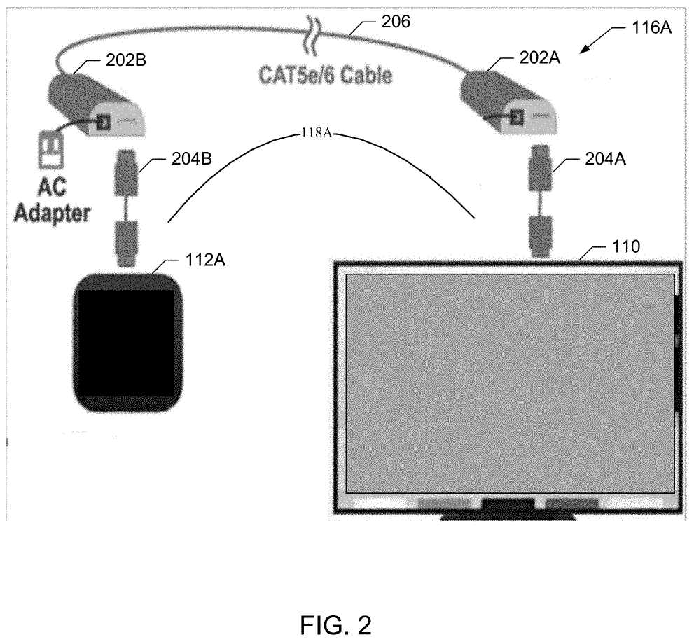

A block diagram of an example extended media connection tapper arrangement for use in the example of FIG. 1 is illustrated in FIG. 2. In the example extended media connection tapper arrangement of FIG. 2, the example media connection tapper 116A that taps the media connection path 118A between the media source device 112A and the media display device 110 is implemented by two example media connection tappers 202A-B. For example, the media connection tapper 116A is implemented by a first media connection tapper 202A connected to the media display device 110 via a first example connection 204A, such as a first HDMI connection (e.g., a first HDMI cable) or any other connection, and by a second media connection tapper 202B connected the media source device 112A via a second example connection 204B, such as a second HDMI connection (e.g., a second HDMI cable) or any other connection. Furthermore, the first and second media connection tappers 202A-B are interconnected by a third example connection 206, such as an Ethernet connection or any other connection, which may be different from, or the same as, one or both of the example connections 204A-B. In this manner, the third example connection 206 and the first and second media connection tappers 202A-B implementing the media connection tapper 116A bridge the first connection 202A and the second connection 202B to implement the media connection path 118A between the media display device 110 and the media source device 112A, thereby allowing media signals to be transmitted from the media source device 112A to the media display device 110. Such an arrangement can extend the length/range of the media connection path 118A able to be bridged by the media connection tapper 116A.

A block diagram of an example media connection tapper 116 that may be used to implement one or more of the example media connection tappers 116A-C of FIGS. 1-2 is illustrated in FIG. 3. For convenience and without loss of generality, the example of FIG. 3 is described from the perspective of the example media connection tapper 116 being used to implement the media connection tapper 116A of FIG. 1. Turning to FIG. 3, the example media connection tapper 116 includes a first example connector 305 to communicatively couple the media connection tapper 116 with a media connector of the media source device 112A. For example, the first example connector 305 can be implemented by one or more of an HDMI connector, a USB connector, an Ethernet port, etc., and/or any other appropriate connector to couple with a corresponding connector of the media source device 112A to implement the media communication path 118A. The example media connection tapper 116 also includes a second example connector 310 to communicatively couple the media connection tapper 116 with a media connector of the media display device 110. For example, the second example connector 310 can be implemented by one or more of an HDMI connector, a USB connector, an Ethernet port, etc., and/or any other appropriate connector to couple with a corresponding connector of the media display device 110 to implement the media communication path 118A.

In the illustrated example of FIG. 3, the media connection tapper 116 further includes an example signal tapper 315 to pass media signals transmitted from the first connector 305 to the second connector 310 or, more generally, between the first connector 305 and the second connector 310, as shown, to bridge the media communication path 118A between the media display device 110 and the media source device 112A. The signal tapper 315 of the illustrated example also copies, mirrors, or otherwise provides access to media data, including image data (e.g., video data) and audio data, of the media signal(s) transmitted from the first connector 305 to the second connector 310 or, more generally, between the first connector 305 and the second connector 310. For example, the signal tapper 315 provides one or more example processing elements of the media connection tapper 116 with access to the image data and audio data of the media data transmitted from the first connector 305 to the second connector 310 for use in determining application identification information for a media application executed by the media source device 112A to provide the media data.

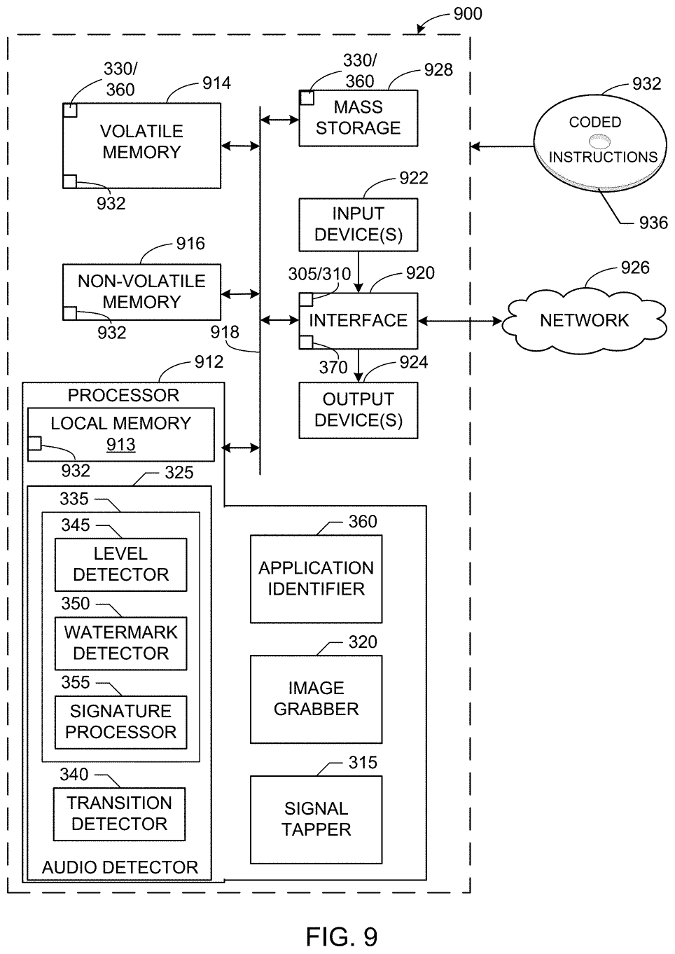

In the illustrated example of FIG. 3, such example processing elements of the media connection tapper 116 include an example image grabber 320 and an example audio detector 325. The example image grabber 320 of the media connection tapper 116 operates to access the image data and capture image frames of the media data in a media signal transmitted from the media source device 112A to the media display device 110 and made accessible by the signal tapper 315. For example, the image grabber 320 may decode and process the image data according to any appropriate media protocol to obtain image frames of video represented by the media data. In the illustrated example, the image grabber 320 stores the captured image frames (corresponding to the media transmitted from the media source device 112A to the media display device 110) in example image storage 330. The example image storage 330 may be implemented by any type of storage and/or memory device, a database, etc., such as the mass storage device 928 and/or the volatile memory 914 included in the example processing system 900 of FIG. 9, which is described in further detail below.

The example audio detector 325 of the media connection tapper 116 operates to detect audio transitions in audio data of the media data transmitted in the media signal transmitted from the media source device 112A to the media display device 110 and made accessible by the signal tapper 315. For example, the audio detector 325 is structured to detect audio transitions indicative of a potential start or change of provided media. As such, these audio transitions can act a s proxy or indicator of a when a media application has been executed to provide the media.

For example, the audio detector 325 includes an example audio condition evaluator 335 and an example transition detector 340 to detect such audio transitions in the audio data corresponding to the media transmitted from the media source device 112A to the media display device 110 and made accessible by the signal tapper 315. In the illustrated example of FIG. 3, the audio condition evaluator 335 detects whether the audio data corresponds to a valid audio condition indicative of valid media data being transmitted from the media source device 112A to the media display device 110 at the present time, or whether the audio data does not correspond to a valid audio condition, thereby indicating that valid media is probably not being transmitted from the media source device 112A to the media display device 110 at the present time. Examples of valid audio conditions that may be detected by the audio condition evaluator 335 include, but are not limited to, the audio data satisfying (e.g., meeting or exceeding) an audio level threshold, the audio data including valid audio watermarks, etc. Examples of valid audio conditions not being detected by the audio condition evaluator 335 include, but are not limited to, the audio data not satisfying (e.g., being less than) the audio level threshold, the audio data not including valid audio watermarks, etc.

In response to detecting a valid audio condition, the example transition detector 340 evaluates the detected valid audio condition to determine whether it corresponds to an audio transition to be used to trigger processing to identify the media application responsible for providing the media data. In the illustrated example, the transition detector 340 determines whether the valid audio condition was detected by the audio condition evaluator 335 after a time period in which no valid audio conditions have been detected and, thus, which indicates the valid audio condition corresponds a start or change of the media application providing the media data. If the valid audio condition was detected after a time period in which no valid audio conditions have been detected, the transition detector 340 indicates that an audio transition has been detected. Otherwise, the transition detector 340 indicates that no audio transition has been detected. The time period may be user configurable, initialized in advance, hard-coded, etc., and may have any appropriate duration (e.g., tens of second, a minute, several minutes, etc.).

To detect valid audio conditions, the audio condition evaluator 335 of the illustrated example includes one or more of an example level detector 345, an example watermark detector 350 and an example signature processor 355. The level detector 345 of the illustrated example detects an audio level of the audio data corresponding to the media signal transmitted from the media source device 112A to the media display device 110 and made accessible by the signal tapper 315. For example, the level detector 345 may measure a signal strength level, a volume level, etc., of the level detector 345. The level detector 345 of the illustrated example further compares the detected audio level of the audio data to an audio level threshold, which may be configurable, initialized in advance, hard-coded, etc. In such examples, the transition detector 340 may indicate that an audio transition has been detected when the detected audio level of the audio data satisfies (e.g., meets or exceeds) the audio level threshold after not having satisfied the first audio level threshold for the time period.

The example watermark detector 350 of the audio detector 325 detects watermarks in the audio data corresponding to the media signal transmitted from the media source device 112A to the media display device 110 and made accessible by the signal tapper 315. Examples of audio watermarking techniques that can be implemented by the watermark detector 350 include, but are not limited to, examples described in U.S. Patent Publication No. 2010/0106510, which was published on Apr. 29. 2010; in U.S. Pat. No. 6,272,176, which issued on Aug. 7, 2001; in U.S. Pat. No. 6,504,870, which issued on Jan. 7, 2003; in U.S. Pat. No. 6,621,881, which issued on Sep. 16, 2003; in U.S. Pat. No. 6,968,564, which issued on Nov. 22, 2005; in U.S. Pat. No. 7,006,555, which issued on Feb. 28, 2006; and/or in U.S. Patent Publication No. 2009/0259325, which published on Oct. 15, 2009, all of which are hereby incorporated by reference in their respective entireties. In such examples, the transition detector 340 may indicate that an audio transition has been detected when the watermark detector 350 has detected a first watermark (e.g., a valid watermark) in the audio data after no audio watermarks have been detected in the audio data for the time period.

The example signature processor 355 of the audio detector 325 generates signatures from the audio data corresponding to the media signal transmitted from the media source device 112A to the media display device 110 and made accessible by the signal tapper 315. The signature processor 355 further analyzes the characteristics of the generated signatures (e.g., by comparing against one or more reference signatures provided by central facility 190) to determine whether a valid audio condition has been detected. Examples of signaturing techniques that can be implemented by the signature processor 355 include, but are not limited to, examples described in U.S. Pat. No. 4,677,466, which issued on Jun. 30, 1987; in U.S. Pat. No. 5,481,294, which issued on Jan. 2, 1996; in U.S. Pat. No. 7,460,684, which issued on Dec. 2, 2008; in U.S. Publication No. 2005/0232411, which published on Oct. 20, 2005; in U.S. Publication No. 2006/0153296, which published on Jul. 13, 2006; in U.S. Publication No. 2006/0184961, which published on Aug. 17, 2006; in U.S. Publication No. 2006/0195861, published on Aug. 31, 2006; in U.S. Publication No. 2007/0274537, which published on Nov. 29, 2007; in U.S. Publication No. 2008/0091288, which published on Apr. 17, 2008; and/or in U.S. Publication No. 2008/0276265, which published on Nov. 6, 2008, all of which are hereby incorporated by reference in their respective entireties. In such examples, the transition detector 340 may indicate that an audio transition has been detected when a valid signature is able to be generated from the audio data after no valid signatures have been generated from the audio data for the time period.

The example media connection tapper 116 of FIG. 3 further includes an example application identifier 360 to determine, in response to detection of an audio transition by the audio detector 320, application identification information in an image frame captured by the image grabber 320 prior to the detection of the audio transition. As described above and in further detail below, the application identification information determined by the application identifier 360 is to identify a media application executed by the media source device 112A to provide the media data transmitted in the media signal to the media display device 110 and made accessible by the signal tapper 315. For example, in response to detection of an audio transition by the audio detector 320, the application identifier 360 of the illustrated example accesses a previously captured image frame in the image storage 330 such that the captured image frame has a capture time prior to a time of the detected audio transition. For example, the capture time of the previously captured image frame accessed by the application identifier 360 may be immediately prior the time of the detected audio transition, within a time window of the detected audio transition (which may be configurable initialized in advance, hard-coded, etc.), etc. The application identifier 360 then performs image processing on the previously captured image frame to identify graphical data of the image frame matching reference graphical data corresponding to at least one of a set of one or more reference media applications. The application identifier 360 then determines the application identification information based on the matching graphical data identified in the previously captured image frame.

For example, the reference graphical data processed by the application identifier 360 can include logos and/or other indicator(s), such as menus, etc., associated with one or more possible reference media applications capable of being executed by the media source device 112A to provide media data to the monitored media display device 110. In some such examples, the central facility 190 downloads the reference graphical data associated with the reference media applications to the media connection tapper 116 for storage in an example reference storage 365. The example reference storage 365 may be implemented by any type of storage and/or memory device, a database, etc., such as the mass storage device 928 and/or the volatile memory 914 included in the example processing system 900 of FIG. 9, which is described in further detail below. Furthermore, in some examples, the central facility 190 may limit (e.g., based on configuration data) the downloaded reference graphical data to just those one or more reference media applications installed on or otherwise capable of being executed by the media source device 112A.

In some examples, the central facility 190 further downloads reference application identifiers identifying the respective reference media applications, which are stored in the reference storage 365 in association with the reference graphical data for the respective reference media applications. The reference application identifiers may correspond to application names, application serial numbers, etc., and/or any other identifying information. In some such examples, when the application identifier 360 identify graphical data of the image frame matching reference graphical data (e.g., a first one of the reference logos) corresponding to a first one of the reference media applications, the application identifier 360 accesses, from the reference storage 365, a reference application identifier stored in association with the particular reference graphical data (e.g., the first one of the reference logos) matching the graphical data of the previously captured image frame. The application identifier 360 then includes the retrieved reference application identifier in the application identification information, which identifies the media application executed by the media source device 112A to provide the media data transmitted in the media signal to the media display device 110 and made accessible by the signal tapper 315.

The example media connection tapper 116 of FIG. 3 includes an example communication interface 370 to interface with the example network 180 to transmit the application identification information determined by the application identifier 360 to the central facility 190. Additionally or alternatively, the communication interface 370 can be structured to transmit the application identification information determined by the application identifier 360 to the meter 114. The example communication interface 370 can also be used to receive reference graphical data and any associated reference application identifiers for storage in the reference storage 365. The communication interface 370 of the illustrated example can be implemented by any appropriate type and/or number of communication interfaces, such as the interface circuit 920 included in the example processing system 900 of FIG. 9, which is described in further detail below.

As illustrated by the dashed box in the illustrated example of FIG. 3, in some examples, the application identifier 360 and the reference storage 365 may be implemented at the central facility 190. In some such examples, in response to detection of an audio transition, the media connection tapper 116 sends one or more previously captured images having capture time(s) prior to the time of the detected audio transition to the central facility 190. The central facility 190 then performs the image processing on the previously captured image frame(s) to identify reference graphical data corresponding to at least one of the set of possible reference media applications, and uses the matching graphical data to identify the media application of the media source device 112A providing the media data, as described above.

While an example manner of implementing the media connection tappers 116 and 116A-C of FIGS. 1-2 is illustrated in FIG. 3, one or more of the elements, processes and/or devices illustrated in FIG. 3 may be combined, divided, re-arranged, omitted, eliminated and/or implemented in any other way. Further, the example connectors 305-310, the example signal tapper 315, the example image grabber 320, the example audio detector 325, the example image storage 330, the example audio condition evaluator 335, the example transition detector 340, the example level detector 345, the example watermark detector 350, the example signature processor 355, the example application identifier 360, the example reference storage 365, the example communication interface 370 and/or, more generally, the example media connection tappers 116 and/or 116A-C may be implemented by hardware, software, firmware and/or any combination of hardware, software and/or firmware. Thus, for example, any of the example connectors 305-310, the example signal tapper 315, the example image grabber 320, the example audio detector 325, the example image storage 330, the example audio condition evaluator 335, the example transition detector 340, the example level detector 345, the example watermark detector 350, the example signature processor 355, the example application identifier 360, the example reference storage 365, the example communication interface 370 and/or, more generally, the example media connection tappers 116 and/or 116A-C could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example media connection tappers 116 and/or 116A-C, the example connectors 305-310, the example signal tapper 315, the example image grabber 320, the example audio detector 325, the example image storage 330, the example audio condition evaluator 335, the example transition detector 340, the example level detector 345, the example watermark detector 350, the example signature processor 355, the example application identifier 360, the example reference storage 365 and/or the example communication interface 370 is/are hereby expressly defined to include a non-transitory computer readable storage device or storage disk such as a memory, a digital versatile disk (DVD), a compact disk (CD), a Blu-ray disk, etc. including the software and/or firmware. Further still, the example media connection tappers 116 and/or 116A-C may include one or more elements, processes and/or devices in addition to, or instead of, those illustrated in FIG. 3, and/or may include more than one of any or all of the illustrated elements, processes and devices.

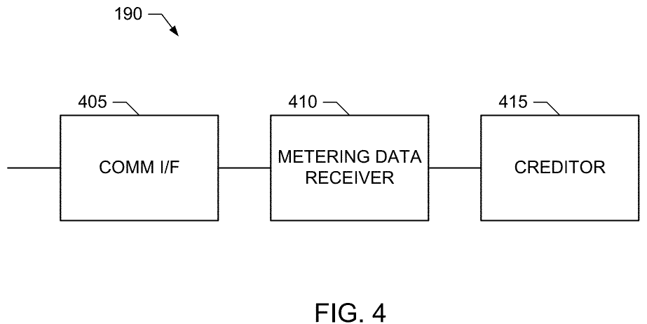

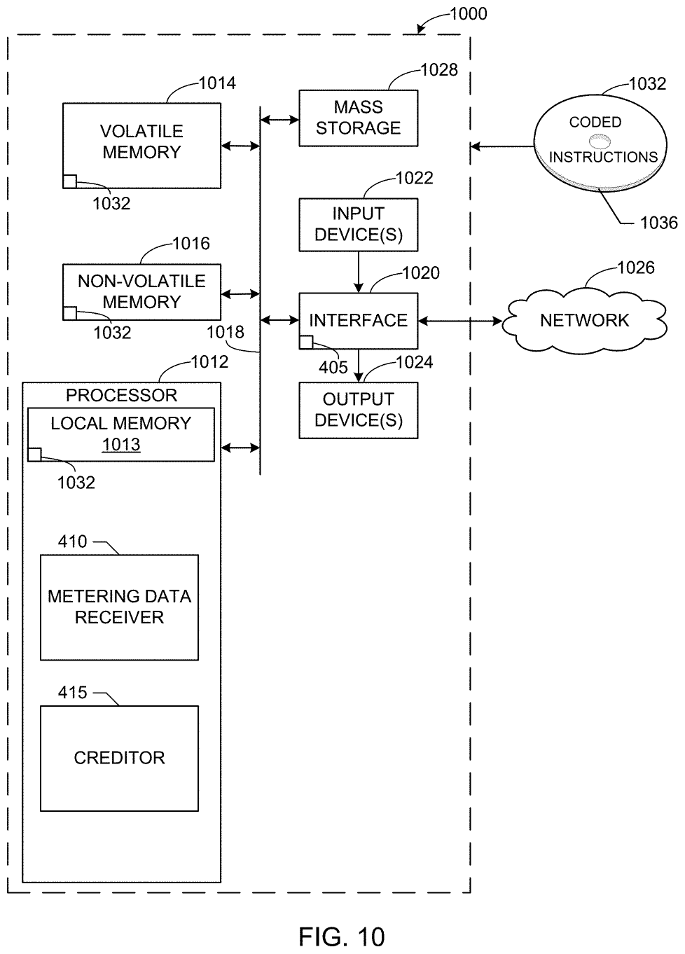

A block diagram of an example implementation of the central facility 190 of FIG. 1 is illustrated in FIG. 4. The example central facility 190 of FIG. 4 includes an example communication interface 405 to interface with the example network 180 to receive media metering data including media application identification information determined by one or more media connection tappers, such as the media connection tappers 116 and/or 116A-C of FIGS. 1-3, in accordance with the teachings of this disclosure. The example communication interface 405 can also be used to transmit reference graphical data and any associated reference application identifiers to one or more media connection tappers, such as the media connection tappers 116 and/or 116A-C of FIGS. 1-3, in accordance with the teachings of this disclosure. The communication interface 405 of the illustrated example can be implemented by any appropriate type and/or number of communication interfaces, such as the interface circuit 1020 included in the example processing system 1000 of FIG. 10, which is described in further detail below.

The example central facility 190 of FIG. 4 also includes an example metering data receiver 410 to access media monitoring information received via the communication interface 405 from meters, such as the example meter 114. The example metering data receiver 410 also accesses the media application identification information received via the communication interface 405 from the media connection tappers, such as the media connection tappers 116 and/or 116A-C of FIGS. 1-3, and/or included in the media monitoring information reported by the meters. The example central facility 190 further includes an example creditor 415 to credit a particular media application of a media source device, such as the media source device 112A, as providing media to a media display device, such as the media display device 110, as reported in the received media monitoring information. For example, the example creditor 415 uses the reported application identification information to identify the particular media application executed by the media source device 112A to provide the monitored media to the media display device 110.

While an example manner of implementing the central facility 190 of FIG. 1 is illustrated in FIG. 4, one or more of the elements, processes and/or devices illustrated in FIG. 4 may be combined, divided, re-arranged, omitted, eliminated and/or implemented in any other way. Further, the example communication interface 405, the example metering data receiver 410, the example creditor 415 and/or, more generally, the example central facility 190 may be implemented by hardware, software, firmware and/or any combination of hardware, software and/or firmware. Thus, for example, any of the example communication interface 405, the example metering data receiver 410, the example creditor 415 and/or, more generally, the example central facility 190 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example central facility 190, the example communication interface 405, the example metering data receiver 410 and/or the example creditor 415 is/are hereby expressly defined to include a non-transitory computer readable storage device or storage disk such as a memory, a digital versatile disk (DVD), a compact disk (CD), a Blu-ray disk, etc. including the software and/or firmware. Further still, the example central facility 190 may include one or more elements, processes and/or devices in addition to, or instead of, those illustrated in FIG. 4, and/or may include more than one of any or all of the illustrated elements, processes and devices.

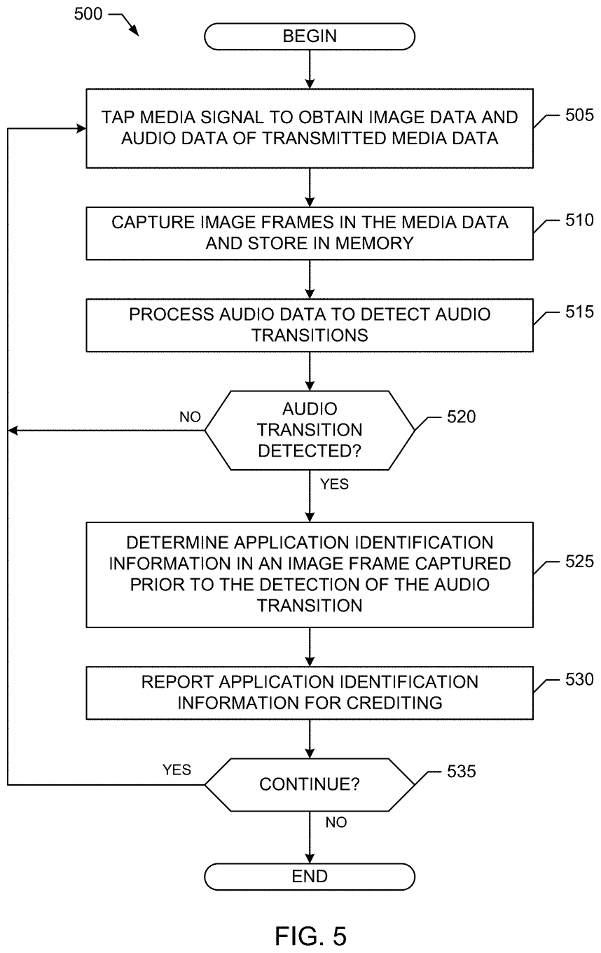

Flowcharts representative of example machine readable instructions for implementing the example media connection tappers 116 and/or 116A-C of FIGS. 12, and/or 3, and the example central facility 190 of FIGS. 1 and/or 4, are shown in FIGS. 5-8. In these examples, the machine readable instructions comprise one or more programs for execution by a processor, such as the processor 912 and/or 1012 shown in the example processor platforms 900 and/or 1000 discussed below in connection with FIGS. 9-10. The one or more programs, or portion(s) thereof, may be embodied in software stored on a non-transitory computer readable storage medium such as a CD-ROM, a floppy disk, a hard drive, a digital versatile disk (DVD), a Blu-ray disk™, or a memory associated with the processor 912 and/or 1012, but the entire program or programs and/or parts thereof could alternatively be executed by a device other than the processor 912 and/or 1012, and/or embodied in firmware or dedicated hardware (e.g., implemented by an ASIC, a PLD, an FPLD, discrete logic, etc.). Further, although the example program(s) is(are) described with reference to the flowcharts illustrated in FIGS. 5-8, many other methods of implementing the example media connection tappers 116 and/or 116A-C of FIGS. 12, and/or 3, and the example central facility 190 of FIGS. 1 and/or 4, may alternatively be used. For example, with reference to the flowcharts illustrated in FIGS. 5-8, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 5-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended. Also, as used herein, the terms “computer readable” and “machine readable” are considered equivalent unless indicated otherwise.

An example program 500 that may be executed to implement the example media connection tapper 116 of FIG. 3 is represented by the flowchart shown in FIG. 5. For convenience and without loss of generality, execution of the example program 500 is described from the perspective of the media connection tapper 116 of FIG. 3 being used to implement the example media connection tapper 116A of FIG. 1. With reference to the preceding figures and associated written descriptions, the example program 500 of FIG. 5 begins execution at block 505 at which the example signal tapper 315 of the media connection tapper 116 taps a media signal transmitted from the first connector 505, which is in communication with the media source device 112A, to the second connector 510, which is in communication with the media display device 110, as described above. At block 510, the example image grabber 320 of the media connection tapper 116 captures image data corresponding to image frames of the media data in the media signal tapped by the example signal tapper 315, as described above. At block 515, the example audio detector 325 processes the audio data of the media data in the media signal tapped by the signal tapper 315 to detect audio transitions in the audio data, as described above. If an audio detection is detected (block 520), processing proceeds to block 525. Otherwise, processing returns to block 505 and blocks subsequent thereto to enable the media connection tapper 116 to continue processing the tapped media connection.

At block 525, the example application identifier 360 determines, in response to detection of an audio transition at block 520, application identification information in an image frame captured at block 510 prior to the detection of the audio transition, as described above. As described above, the application identification information identifies a media application executed by the media source device 112A to provide the media data transmitted in the tapped media signal to the media display device 110. At block 530, the application identifier 360 reports the determined application identification information to the example crediting facility 190 for crediting, as described above. If execution is to continue (block 535), then processing returns to block 505 and blocks subsequent thereto to enable the media connection tapper 116 to continue processing the tapped media connection. Otherwise, execution of the example program 500 ends.

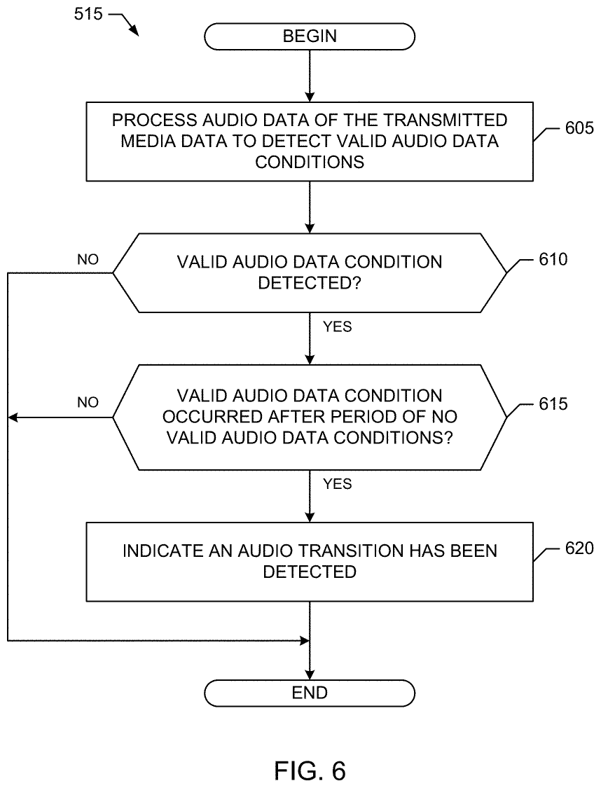

An example program 515 that may be used to implement block 515 of FIG. 5 is illustrated in FIG. 6. For convenience and without loss of generality, execution of the example program 515 of FIG. 6 is described from the perspective of the media connection tapper 116 of FIG. 3 being used to implement the example media connection tapper 116A of FIG. 1. With reference to the preceding figures and associated written descriptions, the example program 515 of FIG. 6 begins execution at block 605 at which the example audio condition evaluator 335 of the audio detector 325 of the media connection tapper 116 processes, as described above, the audio data of the media data in the tapped media signal to determine whether the audio data corresponds to a valid audio condition indicative of valid media data being transmitted from the media source device 112A to the media display device 110 at the present time. At block 610, the audio condition evaluator 335 indicates whether a valid audio condition has been detected. If a valid audio condition has been detected (block 610), at block 615, the example transition detector 340 determines whether the detected valid audio condition occurred after a time period in which no valid audio conditions have been detected. If the detected valid audio condition occurred after a time period in which no valid audio conditions were detected (block 615), then at block 620, the example transition detector 340 indicates and audio transition has been detected, as described above. Execution of the example program 515 of FIG. 6 then ends.

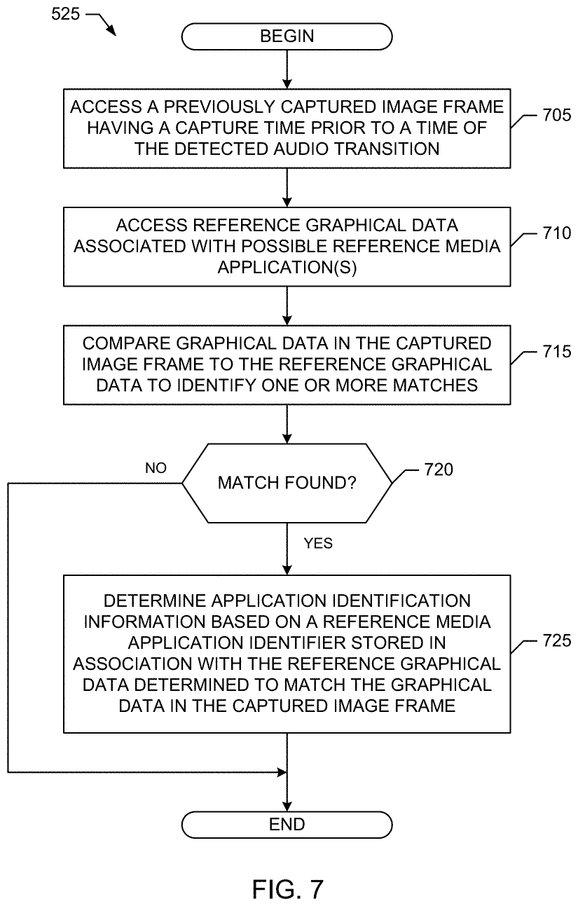

An example program 525 that may be used to implement block 525 of FIG. 5 is illustrated in FIG. 7. For convenience and without loss of generality, execution of the example program 525 of FIG. 7 is described from the perspective of the media connection tapper 116 of FIG. 3 being used to implement the example media connection tapper 116A of FIG. 1. With reference to the preceding figures and associated written descriptions, the example program 525 of FIG. 7 begins execution at block 705 at which the example application identifier 360 of the media connection tapper 116 accesses a previously captured image frame in the image storage 330 such that the captured image frame has a capture time prior to a time of the detected audio transition, as described above. At block 710, the application identifier 360 accesses, from the reference storage 365, reference graphical data (e.g., logos) associated with possible reference media application(s) capable of being executed by the media source device 112A to provide media to the media display device 110, as described above. At block 715, the application identifier 360 compares graphical data in the previously captured image frame to the reference graphical data to identify one or more matches. If a match is found (block 720), then at block 725, the application identifier 360 determines the application identification information based on a reference media application identifier stored in the reference storage 365 in association with the particular reference graphical data determined match the graphical data in the captured image, as described above. Execution of the example program 525 of FIG. 7 then ends.

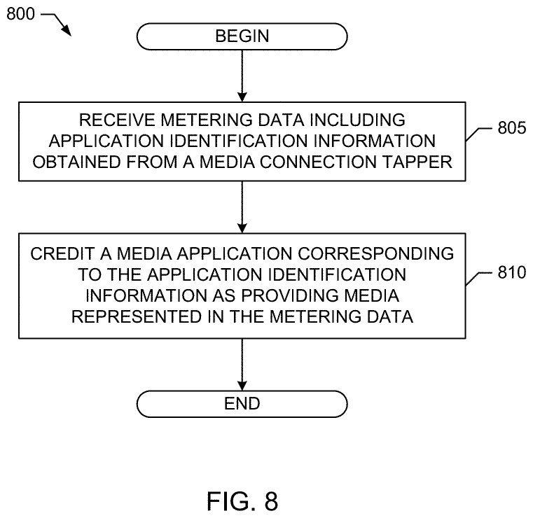

An example program 800 that may be executed to implement the example central facility 190 of FIG. 1 is represented by the flowchart shown in FIG. 8. With reference to the preceding figures and associated written descriptions, the example program 800 of FIG. 8 begins execution at block 805 at which the example metering data receiver 410 of the central facility 190 receives metering data including application identification information obtained from a media connection tapper, such as one of the example media connection tappers 116/116A-C described above. At block 810, the example creditor 415 of the crediting facility 190 uses the application identification information received at block 805 to credit, as described above, a particular media application of a media source device, such as the media source device 112A, as having been executed to providing the monitored media to a media display device, such as the media display device 110, as reported in the received media monitoring information. Execution of the example program 800 then ends.

FIG. 9 is a block diagram of an example processor platform 900 structured to execute the instructions of FIGS. 5, 6 and/or 7 to implement the example media connection tappers 116 and/or 116A-C of FIGS. 1, 2 and/or 3. The processor platform 900 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a digital camera, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer. The hardware processor 912 may be a semiconductor based (e.g., silicon based) device. In this example, the processor 912 implements the example signal tapper 315, the example image grabber 320, the example audio detector 325, the example audio condition evaluator 335, the example transition detector 340, the example level detector 345, the example watermark detector 350, the example signature processor 355 and/or the example application identifier 360.

The processor 912 of the illustrated example includes a local memory 913 (e.g., a cache). The processor 912 of the illustrated example is in communication with a main memory including a volatile memory 914 and a non-volatile memory 916 via a link 918. The link 918 may be implemented by a bus, one or more point-to-point connections, etc., or a combination thereof. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 900, can allow the user to control the computer system and provide data to the computer using physical gestures, such as, but not limited to, hand or body movements, facial expressions, and face recognition.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.). In this example, the interface circuit implements the connectors 305-310 and/or the example communication interface 370.

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID (redundant array of independent disks) systems, and digital versatile disk (DVD) drives. In some examples, the mass storage device(s) 928 may implement the example image storage 330 and/or the example reference storage 365. Additionally or alternatively, in some examples the volatile memory 918 may implement the example image storage 330 and/or the example reference storage 365.

Coded instructions 932 corresponding to the instructions of FIGS. 5, 6 and/or 7 may be stored in the mass storage device 928, in the volatile memory 914, in the non-volatile memory 916, in the local memory 913 and/or on a removable tangible computer readable storage medium, such as a CD or DVD 936.

FIG. 10 is a block diagram of an example processor platform 1000 structured to execute the instructions of FIG. 8 to implement the example central facility 190 of FIG. 1. The processor platform 1000 can be, for example, a server, a personal computer, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer. The hardware processor 1012 may be a semiconductor based (e.g., silicon based) device. In this example, the processor 1012 implements the example metering data receiver 410 and/or the example creditor 415.

The processor 1012 of the illustrated example includes a local memory 1013 (e.g., a cache). The processor 1012 of the illustrated example is in communication with a main memory including a volatile memory 1014 and a non-volatile memory 1016 via a link 1018. The link 1018 may be implemented by a bus, one or more point-to-point connections, etc., or a combination thereof. The volatile memory 1014 may be implemented by SDRAM, DRAM, RDRAM and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a USB, and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1000, can allow the user to control the computer system and provide data to the computer using physical gestures, such as, but not limited to, hand or body movements, facial expressions, and face recognition.

One or more output devices 1024 are also connected to the interface circuit 1020 of the illustrated example. The output devices 1024 can be implemented, for example, by display devices (e.g., an LED, an OLED, an LCD, a CRT, a touchscreen, a tactile output device, a printer and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a DSL, a telephone line, coaxial cable, a cellular telephone system, etc.). In this example, the interface circuit implements the example communication interface 405.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and DVD drives.

Coded instructions 1032 corresponding to the instructions of FIG. 8 may be stored in the mass storage device 1028, in the volatile memory 1014, in the non-volatile memory 1016, in the local memory 1013 and/or on a removable tangible computer readable storage medium, such as a CD or DVD 1036.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A media connection tapper comprising:
an image grabber to capture and store image data corresponding to image frames of media data transmitted in a media signal from a media source device to a media display device;
an audio detector to detect audio transitions in audio data of the media data transmitted in the media signal; and
an application identifier to determine, in response to detection of a first audio transition by the audio detector, application identification information in an image frame captured prior to the detection of the first audio transition, the application identification information to identify a media application executed by the media source device to provide the media data transmitted in the media signal.
